(19) United States
(12) Patent Application Publication
(10) Pub. No.: US 2016/0050362 A1
(43) Pub. Date: Feb. 18, 2016

(54) METHOD OF PROCESSING A DIGITAL IMAGE, COMPUTER READABLE STORAGE MEDIUM OF RECORDING THE METHOD AND DIGITAL PHOTOGRAPHING APPARATUS

(71) Applicant: Samsung Electronics Co., Ltd., Suwon-si (KR)

(72) Inventor: Hong-ju KIM, Changwon-si (KR)

(21) Appl. No.: 14/813,742

(22) Filed: Jul. 30, 2015

(30) Foreign Application Priority Data
Aug. 14, 2014 (KR) 10-2014-0106228

(51) Int. Cl. H04N 5/232; G06F 3/038; G06F 3/041; H04N 7/14

(52) U.S. Cl. CPC H04N 5/23216; H04N 7/142; H04N 5/23293; G06F 3/038; G06F 3/0416; H04N 2007/145; G06F 2203/0339

(57) ABSTRACT

A method of processing a digital image in an automatically transforming image display region on a display unit in a digital image processing apparatus is provided. The method includes receiving an input image, generating a grip signal by detecting a user's grip, detecting a touch by a user and generating a grip signal, detecting the touch of the user on the display unit and generating a first touch signal, setting an image display region, when the grip signal and the first touch signal are generated at the same time, based on the touch location of the user detected on the display unit, and displaying the input image in the image display region set on the display unit.

### CROSS-REFERENCE TO RELATED APPLICATION(S)

This application claims the benefit under 35 U.S.C. §119(a) of a Korean patent application filed on Aug. 14, 2014 in the Korean Intellectual Property Office and assigned Serial number 10-2014-0106228, the entire disclosure of which is hereby incorporated by reference.

### TECHNICAL FIELD

The present disclosure relates to a method of processing a digital image. More particularly, the present disclosure relates to a method of processing a digital image in which according to a grip of a digital image processing apparatus, an image display region where an input image is displayed on a display unit is automatically transformed.

### BACKGROUND

Currently, in a digital image processing apparatus, the size of a display unit has been continuously increasing in line with the increase in the number of pixels in a liquid crystal display (LCD).

In addition to the increase in the size of the display unit, when images or PUIs saved in a digital image processing apparatus are arranged, icons are arranged in bigger sizes and in variety of ways, and thus satisfy the needs of consumers using the digital image processing apparatus.

However, as the size of the digital image processing apparatus becomes smaller, the increasing size of the display unit makes gripping of the digital image processing apparatus unstable and thus deteriorates intuitiveness of PUI.

Therefore, a need exists for a method of processing a digital image in which according to a grip of a digital image processing apparatus, an image display region where an input image is displayed on a display unit is automatically transformed.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of processing a digital image in which according to a grip or touch by a user on a digital image processing apparatus, an image display region where an input image is displayed on a display unit is automatically transformed, thus stabilizing a grip on the digital image processing apparatus and securing a view angle and screen composition required by a user.

In accordance with an aspect of the present disclosure, a method of processing a digital image in an automatically transforming image display region on a display unit in a digital image processing apparatus is provided. The method includes receiving an input image, generating a grip signal by detecting a user's grip, detecting a touch by a user and generating a grip signal, detecting the touch of the user on the display unit and generating a first touch signal, when the grip signal and the first touch signal are generated at the same time, setting the automatically transforming image display region based on the touch location of the user detected on the display unit, and displaying the input image in the automatically transforming image display region set on the display unit.

The setting of the automatically transforming image display region may include, in response to the first touch signal, obtaining first touch information related to the touch location detected on the display unit, and based on the obtained first touch information, setting the automatically transforming image display region.

The automatically transforming image display region may vary according to the touch location of the user detected on the display unit.

The method may further include, while the input image is displayed in the automatically transforming image display region set on the display, generating a photographing signal based on a user input, and when the grip signal and the photographing signal are generated at the same time, photographing the input image.

In accordance with another aspect of the present disclosure, a method of processing a digital image in an automatically transforming image display region on a display unit in a digital image processing apparatus is provided. The method includes receiving an input image, detecting a touch by a user on the display unit and generating a second touch signal, after a first touch signal, in response to the second touch signal, obtaining second touch information related to the touch location detected on the display unit and a number of times being touched, based on the second touch information, setting the automatically transforming image display region, and displaying the input image in the automatically transforming image display region set on the display unit.

In accordance with another aspect of the present disclosure, a digital image processing apparatus is provided. The digital image processing apparatus includes an image receiving unit configured to receive an input image, a display unit configured to display the input image, a grip sensor unit configured to detect a grip of a user and generate a grip signal, a touch sensor unit configured to detect a touch by the user on the display unit and generate a first touch signal, and a control unit configured to set an image display region, when the grip signal and the first touch signal are generated at the same time, based on the location of the touch by the user detected on the display unit, control the input image to be displayed in the image display region set on the display unit.

In response to the first touch signal, the control unit may obtain first touch information related to the location of the touch detected on the display unit and based on the obtained first touch information, set the image display region.

The image display region may vary according to the location of the touch by the user.

The apparatus may further include a user input unit generating a photographing signal based on a user input while the input image is displayed in the image display region set on the display unit, and a photographing unit configured to photograph the input image when the grip signal and the photographing signal are generated at the same time.

In accordance with another aspect of the present disclosure, a digital image processing apparatus is provided. The digital image processing apparatus includes an image receiving unit configured to receive an input image, a display unit configured to display the input image, a touch sensor unit configured to detect a touch by the user on the display unit and generate a second touch signal, after a first touch signal, and a control unit, in response to the second touch signal, configured to obtain second touch information related to the touch location detected on the display unit and a number of times being touched, and control the input image to be displayed in the image display region set on the display unit.

The touch sensor unit may be a touch screen.

The grip sensor unit may include a touch sensor provided on the back surface of the digital image processing apparatus.

In accordance with another aspect of the present disclosure, a computer readable storage medium for storing computer program codes performing an image processing method when the codes are called and executed by a processor is provided. The image processing method includes receiving an input image, generating a grip signal by detecting a user's grip, detecting a touch by a user and generating a grip signal, detecting the touch of the user on the display unit and generating a first touch signal, when the grip signal and the first touch signal are generated at the same time, setting an image display region based on the touch location of the user detected on the display unit, and displaying the input image in the image display region set on the display unit.

In accordance with another aspect of the present disclosure, a computer readable storage medium for storing computer program codes performing an image processing method when the codes are called and executed by a processor is provided. The image processing method includes receiving an input image, detecting a touch by a user on the display unit and generating a second touch signal, after a first touch signal, in response to the second touch signal, obtaining second touch information related to the touch location detected on the display unit and a number of times being touched, based on the second touch information, setting the image display region, and displaying the input image in the image display region set on the display unit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a grip by a user and visibility of a display unit in a digital image processing apparatus having a display unit with an increased size according to the related art;

FIG. 2 is a block diagram of a digital image processing apparatus in which according to a grip or a touch by a user on the digital image processing apparatus, an image display region is automatically transformed according to an embodiment of the present disclosure;

FIG. 3 is a flowchart of a method of processing a digital image in which an image display region is automatically transformed according to an embodiment of the present disclosure;

FIG. 4 is a flowchart of a method of processing a digital image in which while an input image is displayed in an image display region, an input image is photographed based on a user input according to an embodiment of the present disclosure;

FIG. 5 is a schematic diagram illustrating a digital image processing apparatus displaying an input image in an automatically transformed image display region based on a location touched on a display unit according to an embodiment of the present disclosure;

FIG. 6 is a flowchart of a method of processing a digital image in which an image display region is automatically transformed according to a location touched by a user and a number of times being touched on a digital image processing apparatus according to an embodiment of the present disclosure; and

FIG. 7 is a schematic diagram illustrating a digital image processing apparatus displaying an input image in an automatically image display region based on a touched location and a number of times being touched on a display unit according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As the present disclosure allows for various changes and numerous embodiments, particular embodiments will be illustrated in the drawings and described in the written description. The effects and features of the present disclosure, and a method for achieving those will be clearly understood by referring to embodiments described together with drawings. The present disclosure may, however, be embodied in many different forms and should not be construed as limited to the various embodiments of the present disclosure set forth herein.

While such terms as “first,” “second,” and the like, may be used to describe various components, such components must not be limited to the above terms. The above terms are used only to distinguish one component from another.

In the present specification, it is to be understood that the terms, such as “including” or “having,” and the like, are intended to indicate the existence of the features, or components and are not intended to preclude the possibility that one or more other features, or components thereof may exist or may be added.

Expressions, such as “at least one of,” when preceding a list of elements, modify the entire list of elements and do not modify the individual elements of the list.

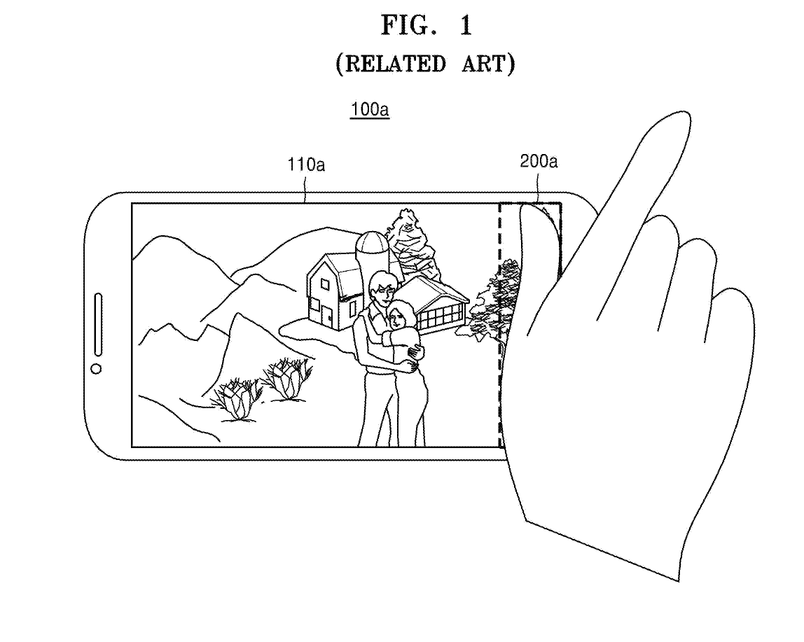

FIG. 1 illustrates a grip by a user and visibility of a display unit in a digital image processing apparatus having a display unit with an increased size according to the related art.

Referring to FIG. 1, in the digital image processing apparatus 100A of the related art, due to the decreasing size of the apparatus and the increasing size of a display unit 40, if a user wants to photograph an input image 110A with keeping a stable grip, a part 200A of the display unit 40 is hidden by the hand of the user.

Accordingly, when a user wants to photograph with the digital image processing apparatus 100A of the related art, not the entire input image 110A output on the display unit 40 is seen and it is inconvenient for the user to photograph an image intended by the user.

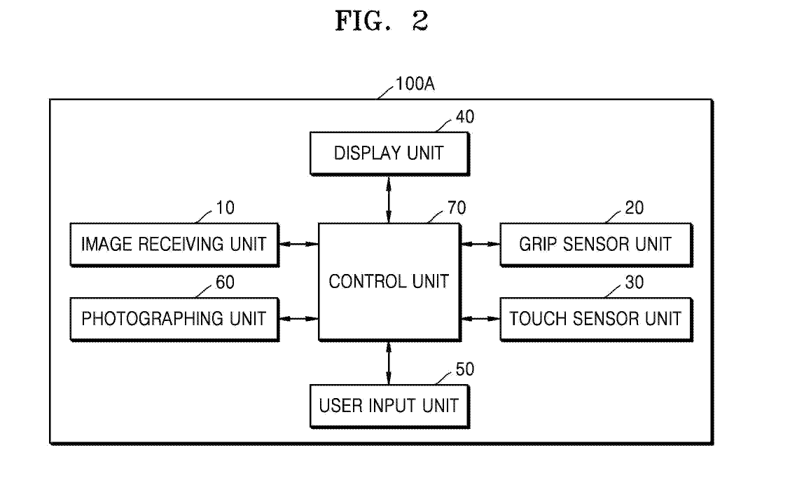

FIG. 2 is a block diagram of a digital image processing apparatus in which according to a grip or a touch by a user on the digital image processing apparatus, an image display region is automatically transformed according to an embodiment of the present disclosure.

Referring to FIG. 2, a digital image processing apparatus 100A according to the embodiment of the present disclosure may be a digital camera, a mobile phone, a smart phone, a laptop computer, a tablet personal computer (PC), an e-book, a digital broadcasting terminal, a personal digital assistant (PDA), or a portable multimedia player (PMP), and may include any apparatus capable of displaying on the display unit 40 information saved in the digital image processing apparatus.

The digital image processing apparatus 100A according to the embodiment of the present disclosure may include an image receiving unit 10, a grip sensor unit 20, a touch sensor unit 30, a display unit 40, a user input unit 50, a photographing unit 60 and a control unit 70.

The elements will now be explained one by one.

The image receiving unit 10 according to the embodiment of the present disclosure may receive an input image.

For example, the input image indicates what is displayed on the display unit 40 of the digital image processing apparatus.

For example, the input image may be a preview image or an image saved in a storage medium. The input image may be input manually by a manipulation of a user or may be input from a web server through a network.

The grip sensor unit 20 according to the embodiment of the present disclosure may detect a grip of a user on the digital image processing apparatus 100A and generate a grip signal.

For example, when the digital image processing apparatus 100A is a camera, the grip sensor unit 20 may include a pressure sensor provided on the front part of the camera and on a release button unit.

In addition, when the digital image processing apparatus 100A is a mobile phone, the grip sensor unit 20 may include a touch sensor placed at the back surface of the mobile phone.

In this case, the grip sensor unit 20 according to the embodiment of the present disclosure may detect the current state of the digital image processing apparatus, such as a grip state on whether or not the user grips the apparatus, and generate a grip signal for controlling an operation of the digital image processing apparatus.

The touch sensor unit 30 according to the embodiment of the present disclosure may detect a touch of the user on the display unit 40 and generate a first or second touch signal.

For example, the first touch signal may be used to obtain first touch information related to the location of a touch detected on the display unit 40.

In addition, the second touch signal may be used to obtain second touch information related to the location of a touch detected on the display unit 40 and the number of times being touched.

In this case, the first and second touch information may be used for the control unit 70 to set an image display region in which an input image is displayed on the display unit 40.

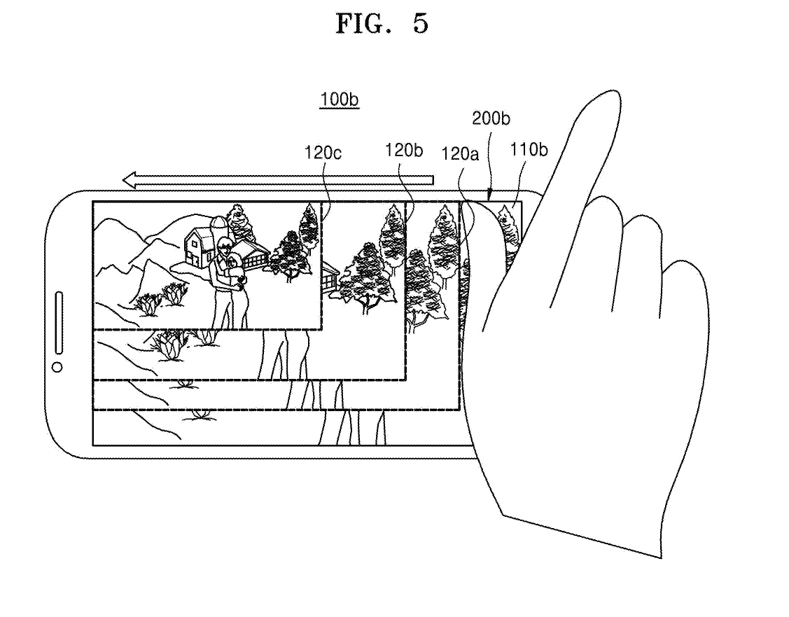

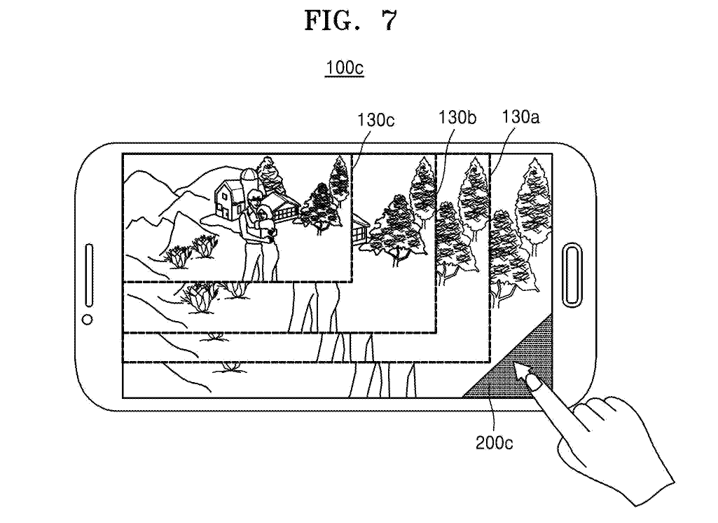

This will be described below with reference to FIGS. 5 and 7.

For example, the touch sensor unit 30 is a sensor through which a command displayed on the screen may be input when the touch sensor unit 30 is pressed by a fingertip and may include a touchpad.

The type of touchpad may include a contact-type capacitance method, a pressure-type resistive overlay method, an infrared detection method, a surface ultrasound transmission method, an integral tension measuring method, a piezo effect method and the like.

More particularly, when the touchpad and the display unit 40 form a mutual layer structure, this may be referred to as a touch screen.

When the display unit 40 and the touchpad form a mutual layer structure to form a touch screen, the display unit 40 may be used as an input device as well as an output device.

The touch screen may be formed to detect a touch pressure as well as the location of a touch input and the area of a touch. In addition, the touch screen may be formed to detect a proximity touch as well as a real touch.

A touch gesture on the touch screen by the user may be detected and information on the touch gesture may be transmitted to the control unit 70. A touch screen module (not shown) may be formed as a separate controller (hardware (H/W)).

Though not shown, a variety of sensor may be provided to the inside or in the proximity of the touch screen in order to detect a touch or a proximity touch on the touch screen.

For example, there is a tactile sensor as an example of a sensor to detect a touch on the touch screen. The tactile sensor is a sensor detecting a contact of a certain object as much as or more than a human being senses. The tactile sensor may detect variety of information including the roughness of a contact surface, the hardness of a contact object and the temperature of a contact point.

As an example of the sensor for detecting a touch on the touch screen, there is a proximity sensor.

The proximity sensor is a sensor which detects the presence of an object approaching to a certain detection surface, or an object existing in the proximity of the detection surface by using electromagnetic power or infrared rays without a mechanical contact. Accordingly, the proximity sensor has a much longer lifespan than that of a tactile sensor and utilization of the proximity sensor is very high.

Examples of the proximity sensor includes a transmission-type photoelectric sensor, a direct reflection-type photoelectric sensor, a mirror reflection-type photoelectric sensor, a high frequency oscillation proximity sensor, a capacitance proximity sensor, a magnetic proximity sensor and an infrared ray proximity sensor.

The user input unit 50 according to the embodiment of the present disclosure may include a key in the digital image processing apparatus 100A for generating an electric signal from a user. The electric signal from the user input unit 50 may be transmitted to the control unit 70 such that the control unit 70 controls the digital image processing apparatus 100A according to the electric signal.

The user input unit 50 according to the embodiment of the present disclosure may generate input data for a user to control operations of the digital image processing apparatus. The user input unit 50 may be implemented with a key pad, a dome switch, a touchpad (a contact-type capacitance method, a pressure-type resistive overlay method, an infrared detection method, a surface ultrasound transmission method, an integral tension measuring method, a piezo effect method and the like), a jog wheel and a jog switch. More particularly, when the touchpad and the display unit 40 to be explained later form a mutual layer structure, this may be referred to as a touch screen.

In this case, the user input unit 50 according to the embodiment of the present disclosure may detect a touch gesture by a user on a touch screen by using a touch screen module (not shown) saved in a memory (not shown), and transmit information on the touch gesture to the control unit 70. The touch screen module (not shown) may be formed as a separate controller (H/W).

The user input unit 50 according to the embodiment of the present disclosure may generate a photographing signal for photographing an input image displayed on an image display region set on a display.

This will be described below with reference to FIG. 5.

The display unit 40 according to the embodiment of the present disclosure may include at least one of a liquid crystal display, a thin film transistor-liquid crystal display, an organic light-emitting diode, a flexible display and a three-dimensional (3D) display.

When the display unit 40 is formed as a touch screen in a mutual layer structure with a touchpad, the display unit 40 may be used as an input device as well as an output device. The touch screen may be implemented to detect a touch input pressure as well as a touch input location and a touched area. In addition, the touch screen may be implemented to detect a proximity touch as well as a real touch.

The display unit 40 according to the embodiment of the present disclosure outputs and displays information being processed in the digital image processing apparatus.

For example, the display unit 40 according to the embodiment of the present disclosure may display an input image received in the image receiving unit 10. In this case, the control unit 70 may control the input image to be displayed in an image display region set on the display unit 40.

Programs stored in the memory (not shown) according to the embodiment of the present disclosure may be classified into a plurality of modules according to functions, and for example, may be classified into a user interface (UI) module and a touch screen module (not shown).

The UI module may provide a specialized UI and graphical UI (GUI) linked to an electronic apparatus. The function of the UI module may be inferred from the name of the UI module intuitively by a person skilled in the art and therefore detailed explanation will be omitted here.

The touch screen module (not shown) may detect a touch gesture of a user on the touch screen and transmit information on the touch gesture to the control unit 70. The touch screen module (not shown) may be formed as a separate controller (H/W).

The photographing unit 60 according to the embodiment of the present disclosure may photograph an input image displayed on the display unit 40 based on a photographing signal generated by the user input unit 50.

For example, when a grip signal and a photographing signal are generated at the same time, the photographing unit 60 may photograph an input image.

In this case, the photographing signal may be generated based on a user input while an input image is displayed in an image display region set on a display.

The whole operation of the digital image processing apparatus 100A according to the embodiment of the present disclosure is generally controlled by the control unit 70. The digital image processing apparatus 100A includes the user input unit 50 which includes keys for generating an electric signal from a user. This electric signal from the user input unit 50 is transmitted to the control unit 70 such that the control unit 70 controls the digital image processing apparatus 100A according to the electric signal.

When a grip signal and a first touch signal are generated at the same time, the control unit 70 according to the embodiment of the present disclosure may set an image display region based on the touch location of the user detected on the display unit 40. For example, in response to the first touch signal, the control unit 70 may obtain first touch information related to the touched location detected on the display unit 40 and set an image display region based on the obtained first touch information.

In this case, the control unit 70 may control an input image to be displayed in the image display region set on the display unit 40. Meanwhile, the image display region may be varied according to the touched location of the user detected on the display unit 40.

In addition, in response to a second touch signal, the control unit 70 according to the embodiment of the present disclosure may obtain second touch information related to the touched location detected on the display unit 40 and the number of times being touched and may set an image display region based on the second touch information.

In this case, the control unit 70 may control the input image to be displayed in the image display region set on the display unit 40. Meanwhile, the image display region may be varied according to the touched location of the user detected on the display unit 40 and the number of times being touched.

Operations of the digital image processing apparatus 100A will now be explained one by one.

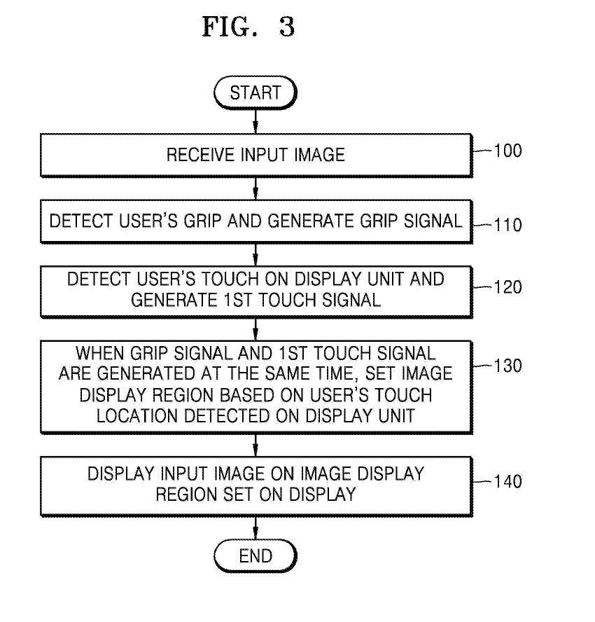

FIG. 3 is a flowchart of a method of processing a digital image in which an image display region is automatically transformed according to an embodiment of the present disclosure.

Referring to FIG. 3, in operation 100, the digital image processing apparatus may receive an input image.

For example, the input image may be a preview image or an image saved in a storage medium. The input image may be input manually by a manipulation of a user or may be input from a web server through a network.

In operation 110, the digital image processing apparatus may detect a grip of a user and generate a grip signal.

For example, the grip signal is for controlling the operation of the digital image processing apparatus and a current state of the digital image processing apparatus, such as a grip state on whether or not the user grips the apparatus may be detected and generated.

In operation 120, the digital image processing apparatus may detect a touch of the user on the display unit 40 and generate a first touch signal.

For example, the first touch signal may be used to obtain first touch information related to the location of a touch detected on the display unit 40.

In operation 130, when the grip signal of the operation 110 and the first touch signal of the operation 120 are generated at the same time, the digital image processing apparatus may set an image display region based on the touched location of the user detected on the display unit 40.

For example, the image display region may be set by using the first touch information related to the touched location detected on the display unit 40. In addition, the image display region may be varied according to the touched location of the user detected on the display unit 40.

In operation 140, the digital image processing apparatus may display the input image received in the operation 100 in the image display region set in the operation 130.

Therefore, according to the grip or touch of the user, the digital image processing apparatus enables automatic transformation of the image display region in which an input image is displayed on the display unit 40, thus stabilizing a grip on the digital image processing apparatus and securing a view angle and screen composition required by the user.

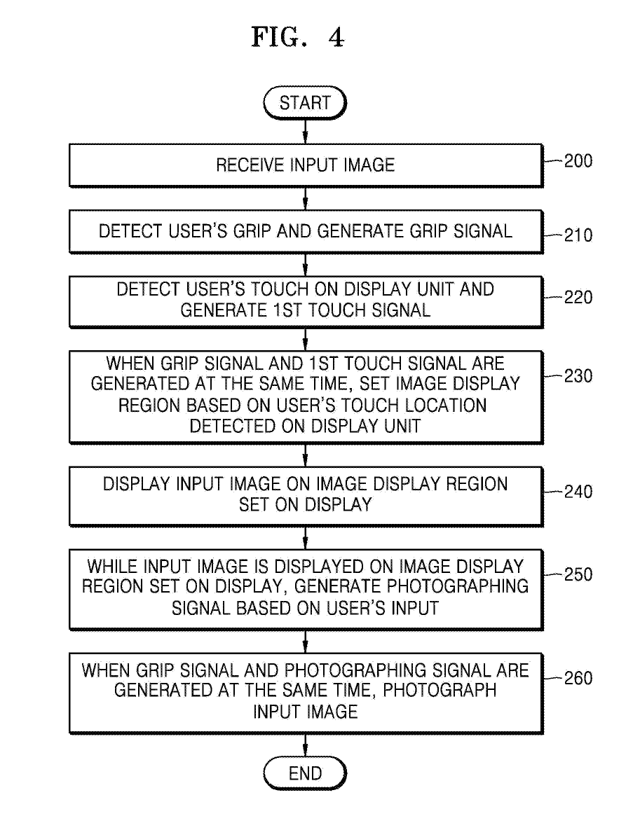

FIG. 4 is a flowchart of a method of processing a digital image in which while an input image is displayed in an image display region, an input image is photographed based on a user input according to an embodiment of the present disclosure.

Referring to FIG. 4, operations 200 through 240 correspond to the operations 100 through 140 and therefore detailed explanation will be omitted here.

In operation 250, while an input image is displayed in an image display region set on the display unit 40, the digital image processing apparatus may generate a photographing signal based on a user input.

For example, while an input image is displayed in the image display region set on a display, a photographing signal may be generated based on a user input.

In operation 260, when the grip signal of the operation 210 and the photographing signal of the operation 220 are generated at the same time, the digital image processing apparatus may photograph an input image.

For example, the input image displayed in the image display region set on the display unit 40 may be photographed.

FIG. 5 is a schematic diagram illustrating a digital image processing apparatus displaying an input image in an automatically transformed image display region based on a location touched on a display unit according to an embodiment of the present disclosure.

Referring to FIG. 5, when a user grips on a digital image processing apparatus 100B with an intention of photographing, the digital image processing apparatus 100B according to the embodiment of the present disclosure may obtain first touch information based on the touched location 200B of the user contacting the display unit 40.

For example, the first touch information may be coordinate information of the touched location of the user on the display unit 40.

In this case, an area excluding a rectangular region with corners corresponding to coordinate information of the location touched by the user may be reset as an image display region 120A through 120C by the digital image processing apparatus 100B. For example, the image display region 120A through 120C may vary according to the location 200B touched by the user detected on the display unit 40.

Therefore, according to the grip or touch of the user, the digital image processing apparatus enables automatic transformation of the image display region in which an input image 110b is displayed on the display unit 40, thus stabilizing a grip on the digital image processing apparatus and securing a view angle and screen composition required by the user.

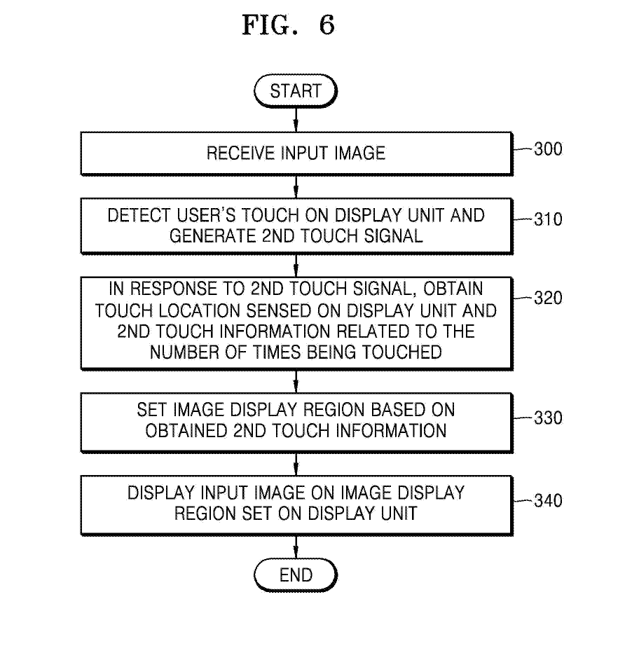

FIG. 6 is a flowchart of a method of processing a digital image in which an image display region is automatically transformed according to a location touched by a user and a number of times being touched on a digital image processing apparatus according to an embodiment of the present disclosure.

Referring to FIG. 6, operations 300 through 340 correspond to the operations 100 through 140 and therefore the explanation will be omitted here.

In operation 310, the digital image processing apparatus may detect a touch by a user on the display unit 40 and generate a second touch signal.

For example, the second touch signal may be used to obtain second touch information related to the touched location detected on the display unit 40 and the number of times being touched.

In operation 320, in response to the second touch signal generated in operation 310, the digital image processing apparatus may obtain second touch information related to the touched location detected on the display unit 40 and the number of times being touched.

For example, the second touch information may be used by the control unit 70 to set an image display region in which an input image displayed on the display unit 40.

In operation 330, based on the second touch information obtained in operation 320, the digital image processing apparatus may set an image display region.

For example, the image display region may be varied according to the touched location by the user detected on the display unit 40 and the number of times being touched.

FIG. 7 is a schematic diagram illustrating a digital image processing apparatus displaying an input image in an automatically image display region based on a touched location and a number of times being touched on a display unit according to an embodiment of the present disclosure.

Referring to FIG. 7, a digital image processing apparatus 100C according to the embodiment of the present disclosure may obtain second touch information based on the touched location 200C by the user contacting the display unit 40 and the number of times being touched.

For example, the second touch information may be coordinate information of the touched location by the user on the display unit 40 and numerical information on the number of times being touched. In this case, according to the touched location by the user and the number of times being touched, the digital image processing apparatus 100C may reset the image display region 130A through 130C. For example, the image display region 130A through 130C may vary according to the touched location 200C by the user detected on the display unit 40 and the number of times being touched.

Therefore, according to touched location by the user and the number of times being touched, the digital image processing apparatus enables automatic transformation of the image display region in which an input image is displayed on the display unit 40, thus securing a view angle and screen composition required by the user.

The device described herein may comprise a processor, a memory for storing program data and executing the program data, a permanent storage, such as a disk drive, a communications port for handling communications with external devices, and user interface devices, including a display, keys, and the like.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the present disclosure, reference has been made to the preferred embodiments illustrated in the drawings, and specific language has been used to describe these embodiments. However, no limitation of the scope of the present disclosure is intended by this specific language, and the present disclosure should be construed to encompass all embodiments that would normally occur to one of ordinary skill in the art.

The present disclosure may be described in terms of functional block components and various processing operations. Such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, where the elements of the present disclosure are implemented using software programming or software elements the disclosure may be implemented with any programming or scripting language, such as C, C++, Java, assembler, or the like, with the various algorithms being implemented with any combination of data structures, objects, processes, routines or other programming elements. Functional aspects may be implemented in algorithms that execute on one or more processors. Furthermore, the present disclosure could employ any number of techniques according to the related art for electronics configuration, signal processing and/or control, data processing and the like. The words “mechanism” and “element” are used broadly and are not limited to mechanical or physical embodiments, but can include software routines in conjunction with processors, and the like.

For the sake of brevity, electronics of the related art, control systems, software development and other functional aspects of the systems (and components of the individual operating components of the systems) may not be described in detail. Furthermore, the connecting lines, or connectors shown in the various figures presented are intended to represent functional relationships and/or physical or logical couplings between the various elements. It should be noted that many alternative or additional functional relationships, physical connections or logical connections may be present in a practical device. Moreover, no item or component is essential to the practice of the present disclosure unless the element is specifically described as “essential” or “critical”.

Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of all methods described herein can be performed in any suitable order unless otherwise indicated herein or otherwise clearly contradicted by context. The use of any and all examples, or language (e.g., “such as”) provided herein, is intended merely to better illuminate the present disclosure and does not pose a limitation on the scope of the present disclosure unless otherwise claimed. Numerous modifications and adaptations will be readily apparent to those skilled in this art without departing from the spirit and scope of the present disclosure.

What is claimed is:

1. A method of processing a digital image in an automatically transforming image display region on a display unit in a digital image processing apparatus, the method comprising:
receiving an input image;
generating a grip signal by detecting a user's grip;
detecting a touch by a user and generating a grip signal;
detecting the touch of the user on the display unit and generating a first touch signal;
setting the automatically transforming image display region, when the grip signal and the first touch signal are generated at the same time, based on the touch location of the user detected on the display unit; and
displaying the input image in the automatically transforming image display region set on the display unit.

2. The method of claim 1, wherein the setting of the automatically transforming image display region comprises:
obtaining, in response to the first touch signal, first touch information related to the touch location detected on the display unit; and
setting the automatically transforming image display region based on the obtained first touch information.

3. The method of claim 1, wherein the automatically transforming image display region varies according to the touch location of the user detected on the display unit.

4. The method of claim 1, further comprising:
generating, while the input image is displayed in the automatically transforming image display region set on the display, a photographing signal based on a user input; and
photographing the input image when the grip signal and the photographing signal are generated at the same time.

5. A method of processing a digital image in an automatically transforming image display region on a display unit in a digital image processing apparatus, the method comprising:
receiving an input image;
detecting a touch by a user on the display unit and generating a second touch signal, after a first touch signal;
obtaining, in response to the second touch signal, second touch information related to the touch location detected on the display unit and a number of times being touched;
setting the automatically transforming image display region based on the second touch information; and
displaying the input image in the automatically transforming image display region set on the display unit.

6. A digital image processing apparatus comprising:
an image receiving unit configured to receive an input image;
a display unit configured to display the input image;
a grip sensor unit configured to:
detect a grip of a user, and
generate a grip signal;
a touch sensor unit configured to:
detect a touch by the user on the display unit, and
generate a first touch signal; and
a control unit configured to:
set an image display region, when the grip signal and the first touch signal are generated at the same time, based on the location of the touch by the user detected on the display unit, and
control the input image to be displayed in the image display region set on the display unit.

7. The apparatus of claim 6, wherein, in response to the first touch signal, the control unit is further configured to:
obtain first touch information related to the location of the touch detected on the display unit, and
set the image display region based on the obtained first touch information.

8. The apparatus of claim 6, wherein the image display region varies according to the location of the touch by the user.

9. The apparatus of claim 6, further comprising:
a user input configured to generate a photographing signal based on a user input while the input image is displayed in the image display region set on the display unit; and
a photographing unit configured to photograph the input image when the grip signal and the photographing signal are generated at the same time.

10. A digital image processing apparatus comprising:
an image receiving unit configured to receive an input image;
a display unit configured to display the input image;
a touch sensor unit configured to:
detect a touch by the user on the display unit, and
generate a second touch signal, after a first touch signal; and
a control unit configured to:
obtain, in response to the second touch signal, second touch information related to the touch location detected on the display unit and a number of times being touched, and
control the input image to be displayed in the image display region set on the display unit.

11. The apparatus of claim 10, wherein the touch sensor unit comprises a touch screen.

12. The apparatus of claim 10, wherein the grip sensor unit comprises a touch sensor provided on the back surface of the digital image processing apparatus.

13. At least one non-transitory computer readable storage medium for storing a computer program of instructions configured to be readable by at least one processor for instructing the at least one processor to execute a computer process for performing the method of claim 1.

14. At least one non-transitory computer readable storage medium for storing a computer program of instructions configured to be readable by at least one processor for instructing the at least one processor to execute a computer process for performing the method of claim 5.
